(19) United States
(12) Patent Application Publication
(10) Pub. No.: US 2019/0229931 A1
(43) Pub. Date: Jul. 25, 2019

(54) DISTRIBUTED TELEPHONE NUMBER LEDGER AND REGISTER

(71) Applicant: Level 3 Communications, LLC, Broomfield, CO (US)

(72) Inventor: Adam C. Uzelac, Rochester, NY (US)

(73) Assignee: Level 3 Communications, LLC, Broomfield, CO (US)

(21) Appl. No.: 16/254,328

(22) Filed: Jan. 22, 2019

Related U.S. Application Data
(60) Provisional application No. 62/619,609, filed on Jan. 19, 2018.

(51) Int. Cl. H04L 9/32; H04L 29/12; G06Q 20/08; G06Q 20/38; H04L 9/06

(52) U.S. Cl. CPC H04L 9/3265; H04L 61/605; H04L 2209/38; G06Q 20/38215; H04L 9/0643; G06Q 20/0855

(57) ABSTRACT

Telephony data can be stored in a distributed ledger via a blockchain structure. In one case, a blockchain structure associated with a particular telephone number may record transactions related to the particular telephone number, such as transfer of ownership, licenses, and usage information. In another case, a blockchain structure may be associated with a plurality of telephone numbers and may record transactions related to each of the plurality of numbers.

### CROSS-REFERENCE TO RELATED APPLICATION

This application is related to and claims priority under 35 U.S.C. § 119(e) from U.S. Patent Application No. 62/619,609, filed Jan. 19, 2018 entitled “Distributed Telephone Number Ledger and Register,” the entire contents of which is incorporated herein by reference for all purposes.

### TECHNICAL FIELD

The present invention relates to telecommunication management. In particular, the present invention relates to managing telecommunication accounts over a distributed ledger.

### BACKGROUND

Telephone numbers are typically maintained on one or more traditional databases which are obfuscated from public view and often kept in a centralized, or mostly centralized, location. As a result, reviewing an ownership or assignment history of a phone number or transferring phone numbers between users is often a lengthy and tedious process including retrieving records from multiple databases and potentially using multiple query methods or procedures.

### SUMMARY

Embodiments of the present invention generally relate to systems and methods for managing a database of telephone numbers, and more specifically for transacting and reviewing transactions involving a decentralized collection of telephone numbers and owners, purchasers, sellers, licensees, and licensors of telephone numbers over a distributed ledger containing immutable record entries. In a first embodiment, a method includes generating a root block including an initial data structure and at least a telephone number, receiving a transaction record over a network, the transaction record including a transaction between a first party and a second party exchanging control of the telephone number, generating a first chain block including a description of the transaction record, linking the first chain block to the root block to create a linked data structure having a linked sequence of the root block and the first chain block, and broadcasting the linked data structure to one or more devices of the network, the one or more devices storing copies of the linked data structure.

In one embodiment, the transaction record is received from both of the first and second parties. In one embodiment, the method further includes receiving a second transaction record including a transaction between the second party and a third party exchanging control of the telephone number, generating a second chain block having a description of the transaction record, linking the second chain block to the first chain block to create a second linked data structure including a second linked sequence of the root block, the first chain block, and the second chain block, and broadcasting the second linked data structure to the one or more devices of the network, the one or more devices storing a copy of the second linked data structure.

In one embodiment, the root block and the first chain block are linked by a hash of the root block, the hash stored in the first chain block. In one embodiment, the first chain block further includes a proof. In one embodiment, transaction record includes a transfer of ownership of the telephone number from the first party to the second party.

In another embodiment, a system includes one or more processors in communication over a network and configured to receive and record telephony data, and a memory including instructions executable by the one or more processors to generate a root block having an initial data structure and including at least a telephone number, receive, over the network, a transaction record including a transaction between a first party and a second party exchanging control of the telephone number, generate a first chain block including a description of the transaction record, linking the first chain block to the root block to create a linked data structure including a linked sequence of the root block and the first chain block, and broadcast the linked data structure to one or more devices of the network, the one or more devices storing a copy of the linked data structure.

In one embodiment, the transaction record is received from both of the first party and the second party. In one embodiment, the instructions are further executable to receive a second transaction record having a transaction between the second party and a third party exchanging control of the telephone number, generate a second chain block including a description of the transaction record, link the second chain block to the first chain block to create a second linked data structure including a second linked sequence of the root block, the first chain block, and the second chain block, and broadcast the second linked data structure to the one or more devices of the network, the one or more devices storing a copy of the second linked data structure.

In one embodiment, the root block and the first chain block are linked by a hash of the root block, the hash stored in the first chain block and wherein the first chain block further comprises a proof. In one embodiment, the transaction record comprises a transfer of ownership of the telephone number from the first party to the second party.

In another embodiment, a method includes generating a root block having an initial data structure including a list of telephone numbers, receiving, over a network, a transaction record including a transaction between a first party and a second party exchanging control of a telephone number, the telephone number included in the list of telephone numbers, generating a first chain block including a description of the transaction record, linking the first chain block to the root block to create a linked data structure having a linked sequence of the root block and the first chain block, and broadcasting the linked data structure to one or more devices of the network, the one or more devices storing a copy of the linked data structure.

In one embodiment, the transaction record is received from both the first party and the second party. In one embodiment, a particular number of transaction records are received, each transaction record associated with two parties, and the second chain block further includes a description of each transaction record. In one embodiment, the root block and the first chain block are linked by a hash of the root block, the hash stored in the first chain block. In one embodiment, the first chain block further includes a proof.

In another embodiment, a system includes one or more processors in communication over a network and configured to receive and record telephony data, and a memory having instructions executable by the one or more processors to generate a root block including an initial data structure including a list of telephone numbers, receive, over the network, a transaction record including a transaction between a first party and a second party exchanging control of a telephone number, the telephone number included in the list of telephone numbers, generate a first chain block including a description of the transaction record, link the first chain block to the root block to create a linked data structure having a linked sequence of the root block and the first chain block, and broadcast the linked data structure to one or more devices of the network, the one or more devices storing a copy of the linked data structure.

In one embodiment, the transaction record is received from both the first party and the second party. In one embodiment, a particular number of transaction records are received, each transaction record associated with two parties, and the second chain block further includes a description of each transaction record. In one embodiment, the root block and the first chain block are linked by a hash of the root block, the hash stored in the first chain block, and wherein the first chain block further includes a proof.

### BRIEF DESCRIPTION OF THE DRAWINGS

FIG. 1A is a diagram illustrating an example of a blockchain data structure which may be used in implementing embodiments of the present disclosure;

FIG. 1B is a system diagram illustrating a distributed ledger blockchain network which may be used in implementing embodiments of the present disclosure;

FIG. 1C is a system diagram illustrating a network of nodes which may be used in implementing embodiments of the present disclosure;

FIG. 2 is a diagram illustrating a system for tracking transactions involving multiple telephone numbers on a blockchain, according to one embodiment of the present disclosure;

FIG. 3 is a diagram illustrating a system for tracking transactions related to a single telephone number on a blockchain, according to one embodiment of the present disclosure;

FIG. 4A is a diagram illustrating a blockchain data structure for tracking transactions related to a single telephone number, according to one embodiment of the present disclosure;

FIG. 4B is a diagram illustrating a blockchain data structure for tracking transactions involving multiple telephone numbers, according to one embodiment of the present disclosure;

FIG. 5 is a flowchart illustrating a method for tracking transactions involving multiple telephone numbers over a distributed ledger, according to one embodiment of the present disclosure;

FIG. 6 is a flowchart illustrating a method for tracking transactions related to a single telephone number over a distributed ledger, according to one embodiment of the present disclosure;

FIG. 7 is a system diagram illustrating a node in a blockchain network, according to one embodiment of the present disclosure; and

FIG. 8 is a diagram illustrating an example of a computing system which may be used in implementing embodiments of the present disclosure.

### DETAILED DESCRIPTION

Phone numbers and other telephony data are typically maintained by single organizations in centralized repositories, such as a database. Vulnerabilities and various other disadvantages are associated with centralization. For example, each centralized database is a singular failure point and, should the database become inaccessible due to service interruptions, hardware failure, or any other reason, the telephony data stored on it is likely to be inaccessible. Centralized storage and curation systems, such as databases, also suffer from administrative congestion in that operations or transactions concerning the stored data, such as the sale or licensing of a telephone number, is recorded by a single system curator. As a result, when many such transactions occur, a slowdown in the overall system is likely to result as each transaction is entered into a queue to be processed by the centralized and singular system.

Centralized systems also fail to provide significant transparency in operations and history because they are often cloistered from public, and even private, access intentionally for security reasons or because of a lack of supporting utilities that are created specifically for the purpose of system transparency. Furthermore, centralized systems often lack any guarantee against post hoc modification of historical records. Though a versioning system may purport to provide a true and accurate history of transactions, there is no mathematical guarantee that the history is in fact true or accurate.

As such, aspects of the present disclosure involve managing data over a distributed blockchain ledger. In one particular example, the present disclosure involves managing telephony data, such as telephone number ownership and transactions of such numbers. Through the systems and methods described, a telephone number may be treated as or considered a digital commodity. Thus, telephone numbers may be efficiently and easily sold, licensed, or otherwise transacted and the record of such transactions processed on a blockchain network and recorded in the ledger for proof of ownership or other reviewing needs. Further, the records are immutable and, once recorded, a record is guaranteed to be a true and accurate representation of the history of the transaction. The records can also be transparent to and reviewable by any holder of an authoritative telephony blockchain, and all members of the blockchain network may hold a copy of the authoritative telephony blockchain. In this manner, the telephony data may be decentralized from a database, providing additional security, operability, and durability of the data.

In one particular embodiment of the present disclosure, each telephone number can be associated with a unique blockchain ledger of transactions and thus provide a complete and accurate history of transactions involving that particular telephone number. In other embodiments, a blockchain ledger of all telephone number transactions can be maintained, ensuring transparency and historical accuracy of all transactions involving telephone numbers from one or more providers.

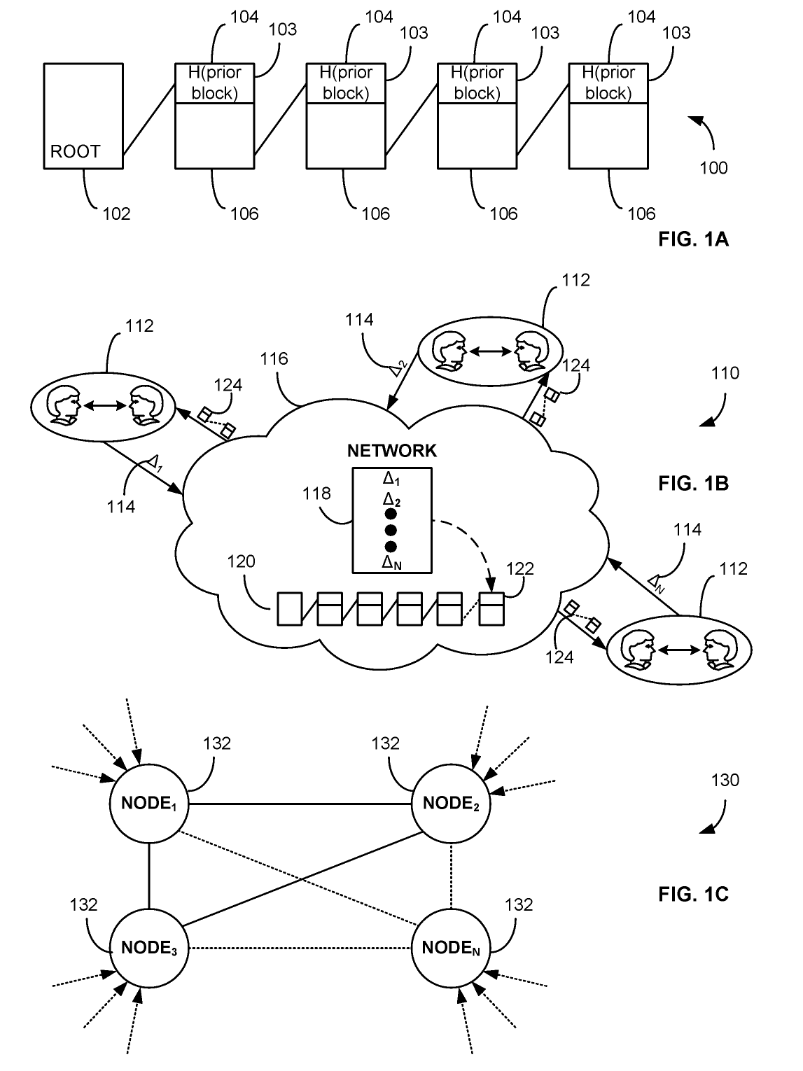

Beginning in FIGS. 1A-C, examples of blockchain networks conforming to aspects of the present disclosure are shown. In particular, FIG. 1A is a diagram illustrating a blockchain data structure 100 made up of a sequence of linked blocks or nodes. A root block 102 can be generated to form a basis for the blockchain data structure 100 and can contain various descriptive data providing insight into an originating context or content of the blockchain data structure 100 such as timing information, design paradigms for later development along the blockchain, identification or organizational information, and the like. The root block 102 can also include data or reference to items having relationships to be tracked by the blockchain data structure 100 such as, for example, telephone numbers. Blocks 103 are cryptographically linked directly and indirectly to the root block 102 by a respective header 104 containing a hash of the preceding block 103 in the chain. For example, the block 103 following the root block 102 would include a hash of the root block in the header 104, while the next block in the chain would include a hash of the preceding block, and so on. Where the preceding block 103 is not the root block 102, the hash stored by the header 104 will include the hash stored by the header 104 and the contents 106 of the preceding block.

While cryptography is more widely known for obfuscating data, in the context of a blockchain, a cryptographic hash is used to validate the veracity of the contents of the previous block. Because a hash function will produce a virtually unique value for every given input, it is such that, so long as the hash header properly maps to the purported input (here, the preceding block) from which it was generated, that input is actually the input which originally generated it. In other words, the veracity of the hash is evidence that the preceding block and its contents have not been altered.

The contents 106 of the blocks 103 in a blockchain 100 may contain virtually any type of data. However, as depicted by FIG. 1B, a particular implementation may store one or more change records, or deltas 114, as the contents 106. For example, a network 116 may construct a new block 118 containing N, or an arbitrary number of, deltas 114. The deltas 114 typically represent a unique transaction 112 between multiple parties, such as the sale of a telephone number from a provider to a customer. Each transaction 112 is recorded and transmitted as a delta 114 to the network 116 where, as depicted in FIG. 1C, one or more nodes 132 in a network 130 of nodes receive the record. The N nodes 132 can be fully connected—in other words, every node communicates with every other node—or can connect to an arbitrary and/or random number of other nodes so that all nodes communicate with many other nodes and thus all nodes directly or indirectly communicate with each other. In any case, all nodes 132 in the network 130 of nodes can receive updates to the blockchain 100 from the network. In some embodiments, each node 132 can further validate the veracity of an updated blockchain 120 before affirming receipt or broadcasting the updated blockchain 120 to the remainder of the network 130.

Using the nodes 132, the network 116 will generate a new block 118 containing each of the N deltas 114. For example, the new block 118 can contain a series of sales of telephone numbers from a provider to a business organization seeking uniform telephone numbers for its offices The new block 118 is then appended onto a current blockchain 120 to create a most recent block 122, which includes the deltas 114 in the block contents 106 as well as an appropriate header 104 linking the most recent block 122 to preceding blocks of the blockchain 100. In some embodiments, the new block 118 is generated after a certain threshold number of deltas 114 are received. In other embodiments, after a certain amount of time, such as every 10 minutes, the network generates a new block 118 out of all deltas 114 that have been received since the last block was generated.

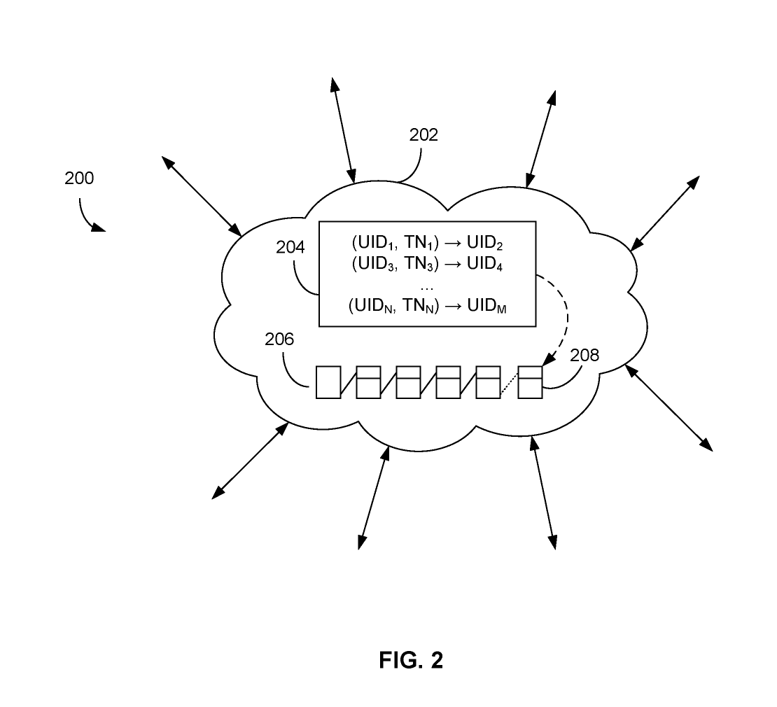

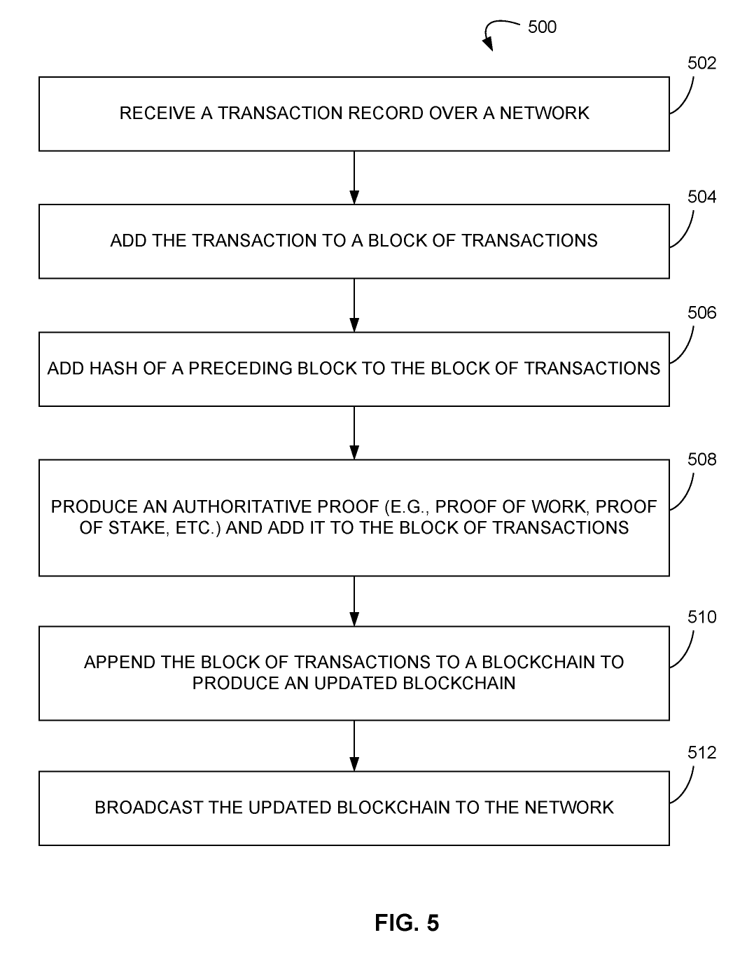

Referring now to FIGS. 2 and 5, a blockchain ledger system 200 and associated method are depicted. In general, the system 200 of FIG. 2 manages transfers of telephone numbers related to a particular provider and the method 500 of FIG. 5 may be performed by the system 200 for updating an associated blockchain. Beginning in operation 502, transaction records are received over a network 202 (operation 502). In one particular embodiment, the transaction records include the transfer of ownership, use, or control of a telephone number for a telecommunications network. In general, telephone numbers are utilized by telecommunications networks to identify particular communication devices accessible through the telephone number. Thus, to transmit communication packets to a device of a user of the network, the network identifies the particular device through an associated or assigned telephone number. In addition, the packets intended for the device may be routed based on the telephone number, such that variations in routing of packets at the components of the network may also be based or identified on the telephone number of the destination device.

Typically, telephone numbers are reserved for particular users of the numbers. In one example, a telecommunications company may be assigned a group of telephone numbers from a governing body. The telecommunications company may then rent or otherwise provide the numbers to customers of the network. In some instances, the customers may obtain or be assigned a group of telephone numbers while other customers are provided with a single telephone number. In this manner, customers to the network may identify the communication devices connected to the network and the network is made aware of a destination to route communications intended for those devices. In another example, a company or individual may purchase (or otherwise be assigned) a telephone number directly from the governing body. To ensure that communications intended for a particular user or device are delivered to the proper destination, each communication device has a unique telephone number through which the device can be accessed. Therefore, proper management of telephone numbers by telecommunication networks provides stability and understanding to the operation of the network.

As mentioned above, networks typically include a database to manage telephony data or other information related to the network. One such database may include a list of telephone numbers assigned to the network and a customer assigned to that number. Through this list, the telecommunications network may perform routing of communications and proper billing of the use of the network by the user. However, centralized telephone number databases are vulnerable and unreliable, as discussed above. Many telecommunications networks include a database within the network itself to store and maintain the telephone numbers for the network and other connected networks. Thus, an outage in the network may affect the performance and reliability of the central telephone number database.

Returning to the system 200 of FIG. 2 and the method 500 of FIG. 5, provided is a decentralized manner for storing and maintaining a database of telephone numbers through a blockchain scheme. Thus, a telecommunications network may utilize the system 200 and method 500 for a telephone number database associated with the telecommunications network. Further, the systems and methods discussed herein may be performed or utilized by any data management party to store and manage any number or types of telephony data. Any telephony data or attributes may be stored and managed by the systems and methods discussed herein, however, telephone numbers referenced for illustrative purposes only. The transaction records received by the system 200 and discussed in the method 500 may therefore be the telephony data, including but not limited to telephone numbers, pertaining to a telecommunications network.

As also discussed above, the system 200 and method 500 may store transactions of a telephone number between two parties. For example, a customer to a network may purchase a telephone number from the network or other governing body. A record of this transaction may then be added to a blockchain for storage and availability to other users of the blockchain. In operation 504, the system generates a block 204 for each transaction included in the transaction records by adding each unique transaction to a block of transactions. For example and illustrated in FIG. 2, block 204 can include the transfer of a first telephone number TN₁ from a first user UID₁ to a second user UID₂ and this transfer can be described in shorthand, depicted as (UID₁,TN₁)→UID₂. The user may be an individual and is referred to as such in this disclosure for illustrative purposes only. The user can also be any of telecommunications provider, an organization with many telephone numbers, a government agency, and the like. Thus, records of an organization transferring a telephone number to an individual, a telecommunication provider to an agency, or any other transfer of a phone number between user types may be placed on a block 204.

An arbitrary number N of transactions can be stored on the new block 204. In some embodiments, the first telephone number can be stored as a string in the transaction record, and the string may be checked against a list of managed telephone numbers in a root block. Further, the first user and the second user can be associated with unique identification numbers stored as string variables. Thus, a transaction record may be a data structure, such as a JSON (JavaScript Object Notation) object, holding a list of string variables providing user identifications for the associated parties and a separate string variable providing the telephone number itself.

The new block 204 can then receive a hash of the preceding block (operation 506). For example, and without imputing limitation, a hash algorithm such as SHA-256 can be used to generate a hash of the preceding block. In a block including only the transaction provided above as an example, the hash may be: “806C1D71841521D1666140D8A43E70F1D4E9A39849304A18627662BBCE79AD3E.” Because this string will be generated whenever the SHA-256 algorithm is applied to the string “(UID₁,TN₁)→UID₂,” the contents of the block can easily be checked merely by reapplying the SHA-256 algorithm and comparing the output to the hash stored in the new block. As will be discussed below, the hash value may be stored in the header of the new block.

An authoritative proof may then be produced and added to the new block 204 (operation 508). In some embodiments, this proof may be proof of work. In other embodiments, the proof may be a proof of stake or a proof of authority. For example, and without imputing limitation, a signature key can be provided as a proof of stake, proof of authority, or both. A proof of work is generally a computationally difficult task or puzzle that is computationally easy and fast to verify. For example, a typical proof of work can include generating a value, sometimes called a nonce, which causes a hash of the block to which it is added to include a specified characteristic such as including a certain number of trailing zeroes. In some embodiments, the proof can be appended onto the block similarly to a signature at the end, or bottom, of the block (e.g., as the last-read component of the block itself).

The new block 204 can then be appended onto a blockchain 206 as a most recent block 208 to produce an updated blockchain and thus preserve the historical record of transactions (operation 510). In one embodiment, the blockchain thus keeps a record of transactions of telephone numbers of a telecommunications network. The updated blockchain can then be broadcast out to the network as appropriate (operation 512). In some embodiments, the network 202 may transmit the updated blockchain to a private set of nodes 132, which each store and update the blockchain as necessary. In other embodiments, the updated blockchain may be transmitted to all participants, node or not, in order to maximize availability and transparency of the transactions.

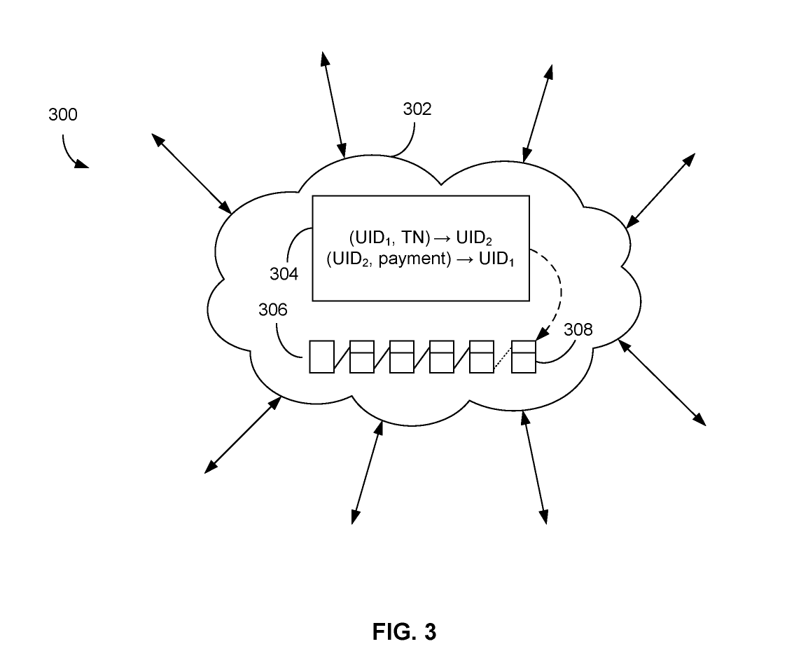

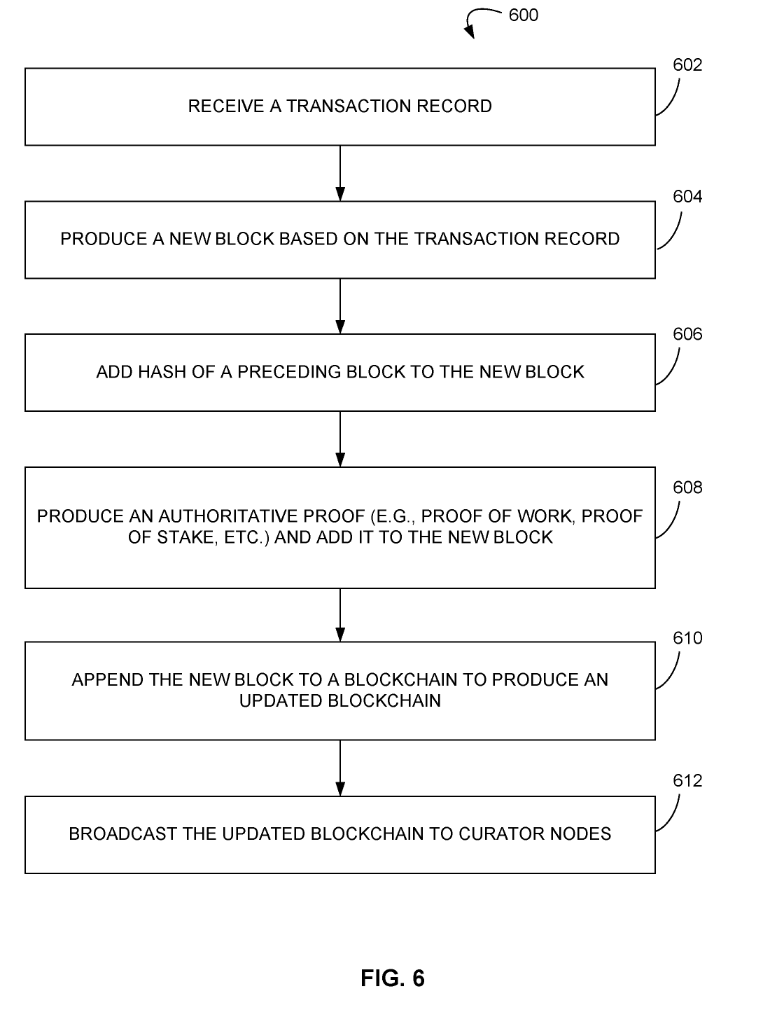

FIG. 3 and FIG. 6 together depict a blockchain ledger system 300 and method 600 for managing a transactional history of a single telephone number. A node network 302 can receive a single transaction record (operation 602). The single transaction can be of various types related to the associated telephone number. For example, and without imputing limitation, the transaction may be a sale of the telephone number from an original owner to a new owner. As another example, the transaction can be a licensing transaction wherein the transaction includes smart contract elements such as automated verification of fee payments and the like. If fee payment verification fails, a new transaction block may automatically generate revoking the license transaction of the preceding block. These examples are understood to be non-limiting and provided for explanatory purposes only and it is understood that other transactions may be recorded by the blockchain ledger system 300.

Having received a transaction record, the node network 302 can generate a new block based on the received transaction record (operation 604). The new block 304 may contain identification of parties (here, UID₁ and UID₂) as well as the payment transferred in exchange for the telephone number. In some embodiments, the new block 304 may contain other information relevant to the transaction such as smart contract elements as discussed above or third-party references for purposes of validation or for integration with resources and/or entities not “off-chain” or separate from the blockchain platform and system itself.

A hash of the preceding block can then be added to the new block 304 (operation 606). As discussed above, a variety of algorithms may be used to generate this hash. However, the hash algorithm used may provide a virtually unique and reproducible value from the previous preceding block as an input value.

An authoritative proof may then be produced by the system 300 (operation 608). The authoritative proof can be of various forms, as discussed above. In a typical blockchain system, a proof of work may be used. However, in some embodiments, a proof of authority or stake is similarly effective.

The new block 304 is appended to the telephone number blockchain 306 to form an updated blockchain (operation 610). The resultant updated blockchain can then be transmitted to relevant entities (operation 612). In some embodiments, the relevant entities may simply be all members of the overall network and provide a fully transparent system. In other embodiments, curating nodes or only members to the transaction may receive the updated blockchain.

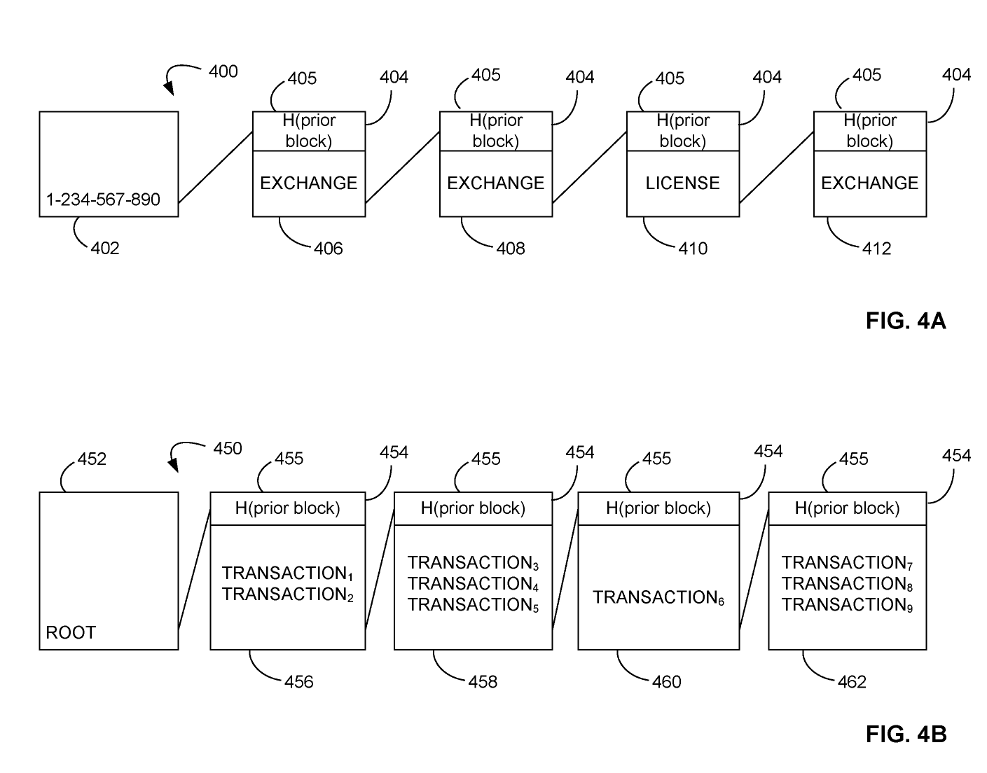

FIGS. 4A and 4B depict a first blockchain 400 associated with a single telephone number and a second blockchain 450 for recording all transactions having to do with a group of numbers, respectively. In some embodiments, blockchains 400 and 450 may exist isolated from and in parallel to each other. In other embodiments, either or both of blockchain 400 and 450 may include internal references between each other. For example, TRANSACTION, of block contents 456 may include a reference to EXCHANGE of block contents 406, and vice versa, through the use of a hash of the referenced block and likewise. In this manner, multiple blockchains 400 and 450 serving distinct purposes can be intertwined or otherwise linked together to create a blockmesh. Further, in some embodiments, successfully producing a cross-reference to maintain the blockmesh can be utilized as a proof of work in lieu of solving an arbitrary hashing puzzle as discussed above.

Blockchain 400 includes a root block 402 which contains a telephone number and can contain other information associated with the telephone number such as date of first assignment, provider information, and the like. In some embodiments, associations with other telephone numbers, group assignments, various classifications and more may also be included in the root block 402.

The root block 402 can be generated at a first acquisition of the telephone number by a provider utilizing the blockchain ledger system 300. The root block 402 may also be generated when the telephone number itself becomes available for consumer purposes and may be generated by a governmental agency. In some embodiments, the root block 402 may be generated post hoc, or after the telephone number has been made available and gone through multiple transactions. In such a case, the generated root block 402 and any subsequent blocks leading up to a current ownership can be approximated using publicly accessible or proprietary information regarding the history of the telephone number.

The remainder of the blockchain 400 is may depend from the root block 402 in chronological sequence as a series of blocks 404 including respective block headers 405 and block content 406, 408, 410, 412. The block headers 405 may contain a hash of the preceding block 404 or 402, thus linking each block 404 to a preceding block 404 or root block 402 before it via hash function.

Various data can be stored in the block content 406, 408, 410, 412. Here, content 406, 408, and 412 include exchange transactions, denoting that ownership of the telephone number contained in the root block 402 has transferred between parties. The exchange information may include party details, various contact information, and payment information. The content 410 includes a license transaction rather than exchange. For example, the license transaction may include a lease agreement for the respective telephone number such as for a particular “1-800” number or the like. In some embodiments, smart contract elements may be included in the content 406, 408, 410, 412. For example, the license transaction of content 410 can include scheduled verifications of payment to a particular account and, should the verification of payment fail at one of the scheduled times, the license may expire. In some embodiments, included smart contract elements can cause a new transaction block to be appended to the blockchain 400 as rights associated with the telephone number stored in the root block 402 either revert or otherwise adjust due to conditions encapsulated by the smart contract elements.

Blockchain 450 includes a root block 452 which can simply be a “dummy” block (e.g., a block containing empty values and simply used as a foundation for the remainder of the associated blockchain) or can contain various identifying data and information. In some embodiments, the root block 452 may contain provider information. In some embodiments, the root block 452 may contain a list of all telephone numbers associated with the blockchain 450. For example, and without imputing limitation, the root block 452 can contain a list of all telephone numbers beginning with “1-617-890-” (e.g., all line numbers of a particular combination of area code and central office code or prefix) resulting in a list of 10,000 unique telephone numbers and associated transactions monitored by one blockchain 452. In this way, all numbers beginning with “1-617-” (e.g., all telephone numbers associated with a particular area code) may be accounted for by approximately 1,000 blockchains each responsible for 10,000 numbers and all area codes in use in the United States (e.g., between 250 and 300) can be accounted for by the same collection of blockchains 452, resulting in less than 300,000 blockchains 452 able to account for transactions involving all telephone numbers in the United States.

Blocks 454 depend from the root block 452 in chronological sequence and each block 454 includes a header 455 which may itself include a hash of the preceding block 454 or root block 452, accordingly. Each block 455 includes content 456, 458, 460, 462. The content 456, 458, 460, 462 can include a record of all transactions involving telephone numbers monitored by the blockchain 452 and generally the content will differ and be unique between each block 455. Here, a first and second transaction are included in the content 456; a third, fourth, and fifth transaction are including in the content 458; a sixth transaction is included in the content 460; and a seventh, eighth, and ninth transaction are including in the content 462.

The transactions can include party identifications, description of the terms of the transaction, identification of the associated telephone number, and other similar information contextualizing and defining the recorded transaction. In some embodiments, the transactions can also include smart contract elements which provide for automated verification of various conditions to the transaction. For example, and without imputing limitation, a transaction can be conditioned on acquisition of an entirety of a group of telephone numbers and so the transaction will only be successful when all of the respective telephone numbers are associated with a similar smart contract element in a transaction. In some embodiments transactions may be further associated with success or failure annotations, thus maintaining a record of all attempted transactions, regardless of success of the transaction.

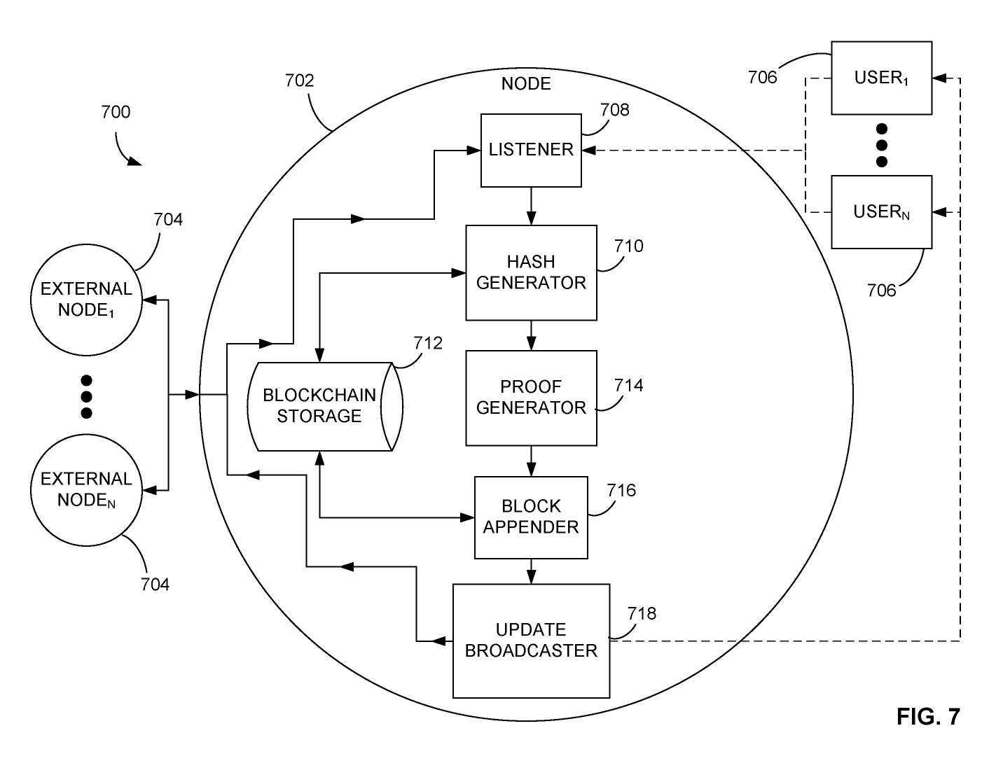

FIG. 7 is a diagram of a node system 700 including a node 702 in communication with N external nodes 704 and N users 706. The node system 700 may manage either or both of the blockchains 400 and 450. The node system 700 may also be the mechanism for updating the blockchains 206 and 306 of systems 200 and 300, respectively, discussed above. In some embodiments, the node system 700 may consist of only a single node 702 responsible for managing all updates from the users 706 and providing the users 706 with an up-to-date blockchain, rather than communicating with any external nodes 704 at all (not depicted).

The node 702 can receive updates to a listener 708. The updates may be received from either or both of the users 706 and the external nodes 704. Furthermore, the listener 708 may passively await transmissions. In some embodiments, the listener 708 can instead issue a regular update query to users 706 or external nodes 704. In some embodiments, where the node network 700 is responsible for multiple blockchains, the listener 708 may further determine whether the transmission is associated with the blockchain ledger system 200 or the blockchain ledger system 300 for recording and managing transactions for a group of telephone numbers or for a single telephone number, respectively, through information included in the transmission. This information can be included as metadata, fielded data, and the like.

The listener 708 may begin construction of a new block 204 or 304 when certain conditions are met. In one embodiment, a new block 204 will be constructed when a transaction record is received from all parties to the transaction. In another embodiment, a new block 304 may be constructed when a sufficient number of transactions have been received. For example, and without imputing limitation, the node 702 may determine that a first received transmission from one party is related to a transaction involving a particular telephone number. Further, the transmission can be determined to involve a telephone number under the purview of a ledger system 200 for recording the transactions involving groups of telephone numbers. A second transaction record can thereafter or simultaneously received from a second party, thus the node 702 may receive multiple identical records of the same transaction from each party. Having received records from all parties to the transaction, the listener 708 may then generate a new block 204 including the transaction.

In some embodiments, the listener 708 can also, either simultaneously or sequentially, determine whether the telephone number being transacted includes a telephone number blockchain 400 managed by the node network 700. If so, the listener 708 may also generate a new block 304 including a record of the transaction.

Where the listener 708 generates a new block 204, the listener 708 may pass the new block 204 to a hash generator 710 once a sufficient number of transactions or span of time has passed and the interim transactions have been added to the generated block. In the case of producing a new block 304, the new block 304 can be immediately passed along to the hash generator 710.

The hash generator 710 may identify an appropriate blockchain held in a blockchain storage 712 associated with the block 204 or 304 which is being appended onto a blockchain. Having identified the associated blockchain, the hash generator 710 can then perform a hashing operation over the most recent block of the associated blockchain, inserting the resultant value into the header 404 or 455 of the new block 304 or 204, respectively.

In some embodiments, the node 702 can also receive claimed updated blockchains from other nodes 702 in the node network 700. Where the listener 708 has received an updated blockchain and passed it along to the hash generator 710, the hash generator 710 can validate the claimed update by reviewing a hash-based proof. The hash-based proof can be generated by a proof generator 714 of each respective node 702 and the proof generator 714 receives a new block 204, 304 from the hash generator 710 and inserts a proof into the new block 204, 304. The hash-based proof can be validated through a hashing check performed by the hash generator 710. Where a node 702 is validating the hash-based proof and the validation is successful, the updated blockchain may be sent back to the blockchain storage 712 to replace the respective old blockchain.

If the validation fails, the updated blockchain can be ignored. In the case of validating an update, once the updated blockchain has replaced the respective old blockchain or been ignored, the node 702 has completed processing data.

Where the node 702 is updating a blockchain with a new block 204, 304, the proof generator 714 receives the new block 204, 304 and generates a proof of some sort. In one embodiment, the proof can be a proof of work such as generating a nonce as discussed above. In other embodiments, the proof can be a signature key or some other verifiable value which may be relatively easily and quickly checked by the hash generator 710.

Once a proof has been generated and inserted into the new block 204, 304 by the proof generator 714, a block appender 716 can received the new block, now including relevant transactional information, a hash of the intended preceding block, and a proof. The block appender 716 can retrieve the associated blockchain from the blockchain storage 712 and append the new block 204, 304 onto the retrieved blockchain, thereby generating an updated blockchain. Having appended the new block 204, 304 onto the blockchain, the block appender 716 can then transmit the updated blockchain to an update broadcaster 718.

The update broadcaster 718 can transmit the updated blockchain to external nodes 704 in the node network 700. The external nodes 704 can then validate and store the updated blockchain in respective blockchain storages 712 as discussed above. In some embodiments, the update broadcaster 718 can also transmit the updated blockchain to users 706. Having transmitted the updated blockchain, the node network 700 is able to maintain a true and accurate transaction history stored across the node network 700 on either or both of a blockchain 400 for a single telephone number or a blockchain 450 for a group of telephone numbers.

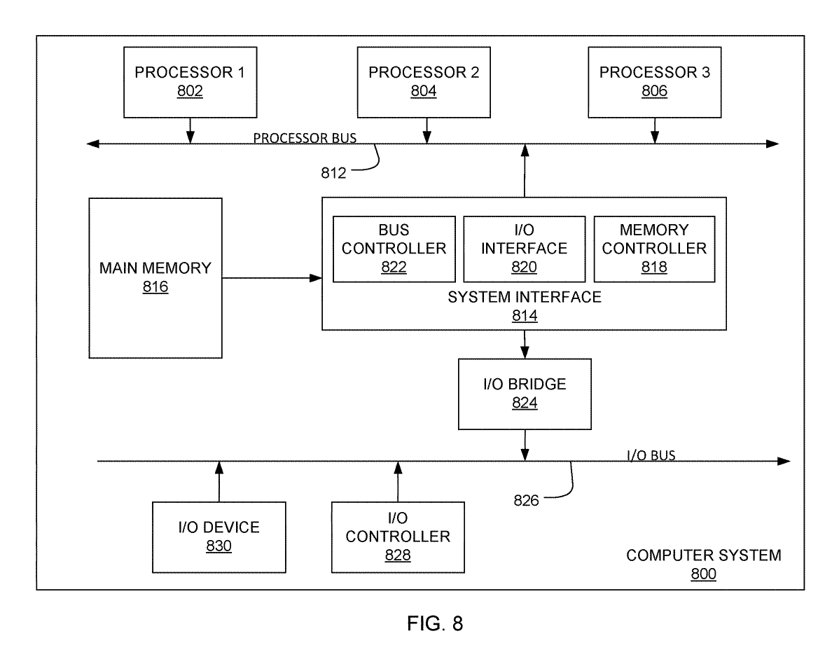

FIG. 8 is a block diagram illustrating an example of a computing device or computer system 800 which may be used in implementing the embodiments of the systems disclosed above. For example, the computing system 800 of FIG. 8 may be the node 702 from FIG. 7 discussed above. The computer system (system) includes one or more processors 802-806. Processors 802-806 may include one or more internal levels of cache (not shown) and a bus controller or bus interface unit to direct interaction with the processor bus 812. Processor bus 812, also known as the host bus or the front side bus, may be used to couple the processors 802-806 with the system interface 814. System interface 814 may be connected to the processor bus 812 to interface other components of the system 800 with the processor bus 812. For example, system interface 814 may include a memory controller 818 for interfacing a main memory 816 with the processor bus 812. The main memory 816 typically includes one or more memory cards and a control circuit (not shown). System interface 814 may also include an input/output (I/O) interface 820 to interface one or more I/O bridges or I/O devices with the processor bus 812. One or more I/O controllers and/or I/O devices may be connected with the I/O bus 826, such as I/O controller 828 and I/O device 830, as illustrated. The system interface 814 may further include a bus controller 822 to interact with processor bus 812 and/or I/O bus 826.

I/O device 830 may also include an input device (not shown), such as an alphanumeric input device, including alphanumeric and other keys for communicating information and/or command selections to the processors 802-806. Another type of user input device includes cursor control, such as a mouse, a trackball, or cursor direction keys for communicating direction information and command selections to the processors 802-806 and for controlling cursor movement on the display device.

System 800 may include a dynamic storage device, referred to as main memory 816, or a random access memory (RAM) or other computer-readable devices coupled to the processor bus 812 for storing information and instructions to be executed by the processors 802-806. Main memory 816 also may be used for storing temporary variables or other intermediate information during execution of instructions by the processors 802-806. System 800 may include a read only memory (ROM) and/or other static storage device coupled to the processor bus 812 for storing static information and instructions for the processors 802-806. The system set forth in FIG. 8 is but one possible example of a computer system that may employ or be configured in accordance with aspects of the present disclosure.

According to one embodiment, the above techniques may be performed by computer system 800 in response to processor 804 executing one or more sequences of one or more instructions contained in main memory 816. These instructions may be read into main memory 816 from another machine-readable medium, such as a storage device. Execution of the sequences of instructions contained in main memory 816 may cause processors 802-806 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 816. Common forms of machine-readable medium may include, but is not limited to, magnetic storage medium; optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages should be understood by the foregoing description, and it should be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it should be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

We claim:

1. A method for managing transactions of telephony data, the method comprising:
generating a root block comprising an initial data structure and including at least a telephone number;
receiving, over a network, a transaction record comprising a transaction between a first party and a second party exchanging control of the telephone number;
generating a first chain block comprising a description of the transaction record;
linking the first chain block to the root block to create a linked data structure comprising a linked sequence of the root block and the first chain block; and
broadcasting the linked data structure to one or more devices of the network, the one or more devices storing a copy of the linked data structure.

2. The method of claim 1, wherein receiving the transaction record further comprises:
receiving a first version of the transaction record from the first party and a second version of the transaction record from the second party; and
validating the transaction record by matching information between the first version of the transaction record and the second version of the transaction record.

3. The method of claim 1, further comprising:
receiving a second transaction record comprising a transaction between the second party and a third party exchanging control of the telephone number;
generating a second chain block comprising a description of the transaction record;
linking the second chain block to the first chain block to create a second linked data structure comprising a second linked sequence of the root block, the first chain block, and the second chain block; and
broadcasting the second linked data structure to the one or more devices of the network, the one or more devices storing a copy of the second linked data structure.

4. The method of claim 1, wherein the root block and the first chain block are linked by a hash of the root block, the hash stored in the first chain block.

5. The method of claim 1, wherein the first chain block further comprises a proof.

6. The method of claim 1, wherein the transaction record comprises a transfer of ownership of the telephone number from the first party to the second party.

7. A system for managing transactions of telephony data, the system comprising:
one or more processors in communication over a network and configured to receive and record telephony data; and
a memory comprising instructions executable by the one or more processors to:
generate a root block comprising an initial data structure and including at least a telephone number;
receive, over the network, a transaction record comprising a transaction between a first party and a second party exchanging control of the telephone number;
generate a first chain block comprising a description of the transaction record;
linking the first chain block to the root block to create a linked data structure comprising a linked sequence of the root block and the first chain block; and
broadcast the linked data structure to one or more devices of the network, the one or more devices storing a copy of the linked data structure.

8. The system of claim 7, wherein the transaction record is received from both of the first party and the second party.

9. The system of claim 7, wherein the memory further comprises instructions executable to:
receive a second transaction record comprising a transaction between the second party and a third party exchanging control of the telephone number;
generate a second chain block comprising a description of the transaction record;
link the second chain block to the first chain block to create a second linked data structure comprising a second linked sequence of the root block, the first chain block, and the second chain block; and
broadcast the second linked data structure to the one or more devices of the network, the one or more devices storing a copy of the second linked data structure.

10. The system of claim 7, wherein the root block and the first chain block are linked by a hash of the root block, the hash stored in the first chain block and wherein the first chain block further comprises a proof.

11. The system of claim 7, wherein receiving the transaction record further comprises instructions to:
receive a first version of the transaction record from the first party and a second version of the transaction record from the second party; and
validate the transaction record by matching information between the first version of the transaction record and the second version of the transaction record.

12. A method for managing transactions involving multiple telephone numbers, the method comprising:
generating a root block comprising an initial data structure including a list of telephone numbers;
receiving, over a network, a transaction record comprising a transaction between a first party and a second party exchanging control of a telephone number, the telephone number included in the list of telephone numbers;
generating a first chain block comprising a description of the transaction record;
linking the first chain block to the root block to create a linked data structure comprising a linked sequence of the root block and the first chain block; and
broadcasting the linked data structure to one or more devices of the network, the one or more devices storing a copy of the linked data structure.

13. The method of claim 12, wherein receiving the transaction record further comprises:
receiving a first version of the transaction record from the first party and a second version of the transaction record from the second party; and
validating the transaction record by matching information between the first version of the transaction record and the second version of the transaction record.

14. The method of claim 12, wherein a particular number of transaction records are received, each transaction record associated with two parties, and the second chain block further comprises a description of each transaction record.

15. The method of claim 12, wherein the root block and the first chain block are linked by a hash of the root block, the hash stored in the first chain block.

16. The method of claim 12, wherein the first chain block further comprises a proof.

17. A system for managing transactions involving multiple telephone numbers, the system comprising:
one or more processors in communication over a network and configured to receive and record telephony data; and
a memory comprising instructions executable by the one or more processors to:
generate a root block comprising an initial data structure including a list of telephone numbers;
receive, over the network, a transaction record comprising a transaction between a first party and a second party exchanging control of a telephone number, the telephone number included in the list of telephone numbers;
generate a first chain block comprising a description of the transaction record;
link the first chain block to the root block to create a linked data structure comprising a linked sequence of the root block and the first chain block; and
broadcast the linked data structure to one or more devices of the network, the one or more devices storing a copy of the linked data structure.

18. The system of claim 17, wherein receiving the transaction record further comprises instructions to:
receive a first version of the transaction record from the first party and a second version of the transaction record from the second party; and
validate the transaction record by matching information between the first version of the transaction record and the second version of the transaction record.

19. The system of claim 17, wherein a particular number of transaction records are received, each transaction record associated with two parties, and the second chain block further comprises a description of each transaction record.

20. The system of claim 17, wherein the root block and the first chain block are linked by a hash of the root block, the hash stored in the first chain block, and wherein the first chain block further comprises a proof.
